(19) United States
(12) Patent Application Publication
(10) Pub. No.: US 2004/0047972 A1
(43) Pub. Date: Mar. 11, 2004

(54) Method for producing protein products which can be emulsified from an oilseed

(76) Inventors: Andreas Wasche, Moosburg (DE); Klaus Muller, Freising (DE); Thomas Luck, Munchen (DE)

Correspondence Address: HOLLANDER LAW FIRM, P.L.C., SUITE 305, 10300 EATON PLACE, FAIRFAX, VA, 22030

(21) Appl. No.: 10/466,148

(22) PCT Filed: Dec. 21, 2001
(86) PCT No.: PCT/EP01/15214

(30) Foreign Application Priority Data
Jan. 13, 2001 (DE) 101 01 326.4

(51) Int. Cl. A23D 7/00

(52) U.S. Cl. 426/601

(57) ABSTRACT

Disclosed is a method for producing emulsifiable protein products from the plant seeds of an oilseed crop, in particular soybeans, in which the plant seeds are comminuted and undergo a de-oiling step and supercritical CO₂ is added to the comminuted plant seeds as a solvent, and crude oil and a de-oiled residue containing the emulsifiable protein products are obtained by means of separation.

### TECHNICAL FIELD

The present invention relates to a method for producing emulsifiable protein products from plant seeds of an oilseed crop, in particular soybeans.

### STATE OF THE ART

The substances fat and water play a vital role in human and animal food cycles not only in their separate forms but in particular in mixed forms due to their inability to mix as dispersion systems or emulsions. However. These emulsions tend to demix on their own so that additional substances have to be added to obtain long-term stable respectively long-term storable emulsions by preventing de-mixing of the two phases oil or fat and water to a thermodynamically stable end state respectively delaying the same until the emulsions have fulfilled their task. Such substances are known as stabilizers or emulsifiers.

Most natural and/or technical emulsions consist of water and oil or fat as unmixable phases. Depending on the composition and behavior of the phases, there are two possible manners of distribution. If water is the external phase and oil the internal one, the result is an O/W emulsion characterized predominantly by water, as is the case, for example, with milk, mayonnaise or ice cream. If oil respectively fat is the external phase and water the internal one, the result is a W/Oil emulsion characterized predominantly by the oil as is the case, for example, with butter, margarine or salves.

Among the many known emulsifiers or emulsion stabilizers are, among other things, also protein isolates which, depending on the method of treatment and method of production, possess special, optimized functional properties. Of special interest is the emulsifiability of such optimized protein isolates used as emulsifiers in particular in the nutritional field. Also suited, in addition to confected protein isolates, as an emulsifiable agent for stabilizing the aforementioned dispersion systems are lecithins. Also known are mixed products of the two substances obtained by applying lecithin on protein isolates by spray drying.

Although lecithins, like protein isolates, stem from the same raw material, for example from soybeans, lupines or rapes, to produce it, the substances have to first be separated. Thus, staying with the example of obtaining protein isolates from soybeans, the soybeans undergo a de-oiling process following respective cleaning and comminution. In this de-oiling process, the soybeans are subjected to an organic solvent, such as for example hexane or ethanol. De-oiling yields a lipid fraction which contains for the most part the entire lecithin content of the soybeans and from which the so-called crude lecithin is obtained by means of subsequent refining. On the other hand, the de-oiling step also yields, apart from the lipid fraction, de-oiled meal, which is rich in proteins and from which proteins can be isolated by means of further extraction steps.

In order to produce lecithin-rich protein isolates, which, as described in the preceding, possess excellent emulsifiability and are, therefore, of great interest in the food industry, the cleaned lecithin, respectively the crude lecithin, and the isolated protein are remixed, for example using a spraying method. Without doubt, such a manner of proceeding is a complicated and, therefore, expensive way of obtaining protein isolates of extraordinary emulsifiability.

A possible alternative, producing not de-oiled and therefore at the same time lecithinized protein isolates, yields products that emulsify well but they are not long-term stable respectively long-term storable, because the oil they contain tends to oxidize giving the products a rancid smell and taste. The same applies to well-emulsified products with a low protein content, which however have not been de-oiled respectively insufficiently de-oiled.

### DESCRIPTION OF THE INVENTION

The object of the present invention is, therefore, to provide a method for producing emulsifiable protein products from the plant seeds of an oilseed crop, in particular from soybeans, in which the aforementioned drawbacks of the state of the art are avoided and, in particular, an emulsifiable protein product, for example a protein isolate, can be obtained which is inexpensive to produce, possesses extraordinary emulsifiablility and is long-term stable and long-term storable.

The solution to the object on which the present invention is based is set forth in claim 1. The advantageous further developing features of the inventive idea are contained in the subclaims as well as in the following description.

A key element of the invention is that preferably the comminuted plant seeds undergo a de-oiling step in such a manner that supercritical CO₂ is added as a solvent to the comminuted plant seeds. Crude oil and a de-oiled residue are yielded by subsequent separation, for example by means of a conventional filtration or decanting step. Another element of the invention is that it was understood that selective use of supercritical CO₂ to de-oil oilseeds can yield a de-oiled refined product from which a protein isolate can be obtained as a protein product that contains a high percentage of lecithin and practically no readily oxidizable oils, by means of state-of-the-art downstream cleaning and fraction processes.

The protein isolates obtained from the aforementioned oilseeds by way of extraction with supercritical CO₂ are distinguished by excellent emulsifiablility, which makes it stand out from comparable products obtained using conventional methods as described in the introduction.

In addition to obtaining the afore-characterized protein isolates of excellent emulsifiablility, other products that are distinguished by a comparably high lecithin content can be obtained from the de-oiled residue, for example in the form of meal, yielded by the de-oiling step conducted with supercritical CO₂. These are protein-reduced meals, such as bulkage or the yielded meal itself but also protein concentrates. The protein content of the yielded product can be set variably between 15 and 95% in dry substance by means of various processing of the de-oiled residue.

Besides optimizing the lecithin content, for example in obtaining protein isolates, the lecithin content of the end product can also be variably reduced by employing an additional entrainer in the CO₂ extraction. For example, propane is suited as an entrainer, by means of which lecithin is extracted from the seed meal in the same manner as the crude oil. If no entrainers are employed and only supercritical CO₂ is utilized as a solvent in the de-oiling step, de-oiled products can flow directly into the human and animal food chain without requiring additional measures. These products even meet the standards of so-called organic food.

### WAYS TO CARRY OUT TH INV NTION, COMMERCIAL APPLICABILITY

In preparing de-oiling plant seeds such as oilseeds, for example soybeans, lupines, sunflower seeds or rape, the seeds are preconditioned by being cleaned, peeled, broken, flaked or even possibly pelletized in such a manner that the subsequent de-oiling step, i.e. the selective use of supercritical CO₂ as the organic solvent, largely completely saturates the correspondingly preconditioned seed. Especially suited is producing flakes or pellets with the aid of a flaking roller to which the peeled and preferably halved plant seeds are conveyed and pressed. In order to inactivate the seed-inherent enzymes to a great extent, the flaking rollers are preheated to a denaturization temperature of preferably below 35° C., which heats the comminuted plant seeds in order to inactivate the seed-inherent enzymes but, for the most part, does not influence the true properties of the seed-inherent proteins. Then the plant seeds preconditioned in this manner are subjected to supercritical CO₂, which acts on the plant seeds at temperatures between 40° C.-69° C. and under pressure conditions between 240-300 bar. Under these de-oiling conditions, all the triglycerides are flushed out of the plant seeds. On the other hand, lecithins but also other so-called fatty escort substances, such as carotinoids, isoflavonoids, tocopherols remain in the de-oiled residue and remain uninfluenced within the plant matrix by the supercritical CO₂.

Surprisingly, it was understood that the fatty escort substances and, in particular, lecithin remain in large amounts in the protein isolate even following standard methods of further extraction for obtaining protein isolates. For this reason, protein isolates obtained in this manner possess extraordinarily high emulsifiability. The protein products, in particular protein isolates, obtained in the preceding manner, can be utilized advantageously immediately without further preparation treatment in all food systems, in which the emulsifying function plays a major role. These are, in particular, products such as bakery goods, sausages and meat products, sweets, chocolates, delicatessen products, beverages, etc.

What is claimed is:

1. A method for producing emulsifiable protein products in the form of lecithin-rich protein isolates from the plant seeds of an oilseed crop, in particular soybeans, in which said plant seeds are comminuted and conveyed to a de-oiling step, wherein for de-oiling supercritical CO₂ is added to said comminuted plant seeds as a solvent at temperatures between 40° C. and 69° C. and under pressures between 240 and 300 bar, crude oil and a de-oiled residue are obtained by means of downstream separation, and
said de-oiled residue is conveyed to a cleaning and fractioning process in order to obtain a protein product which has a high lecithin content and no readily oxidizable oils.

2. The method according to claims 1,
wherein said comminution of said plant seeds occurs after pre-breaking the peeled or unpeeled seeds of said oilseed crop by means of a flaking roller, with said flaking roller being cooled.

3. The method according to claim 1 or 2,
wherein said plant seeds are sorted according to size and shape and subsequently peeled before comminution and/or molding.

4. The method according to one of the claims 1 to 3,
wherein said comminuted plant seeds are flaked or pelletized.

5. The method according to one of the claims 1 to 4,
wherein said peeling step occurs after a so-called cold process, in which the lupine seeds are halved and separated from the pods.

6. The method according to one of the claims 1 to 5,
wherein said flaking roller is cooled to a temperature below the denaturization temperature of the protein products, preferably below 35° C.

7. The method according to one of the claim 1 to 6,
wherein seed-inherent enzymes are inactivated by means of indirect application of heat, with the proteins largely retaining their true properties.

8. The method according to one of the claims 1 to 7,
wherein said separation is combined with mechanical oil separation with presses or with ethanol-water mixtures using centrifuge techniques.

9. An emulsifiable protein product produced according to the method of one of the claims 1 to 8,
wherein said de-oiled residue contains at least one protein isolate which is mixed with lecithin.

10. The emulsifiable protein isolate according to claim 9,
wherein said de-oiled residue contains fatty escort substances.

11. The emulsifiable protein isolate according to claim 10,
wherein said fatty escort substances are, in addition to lecithins, carotinoids, isofalvonoids or tocopherols.

12. A use of said emulsifiable protein isolate according to one of the claims 9 to 11,
wherein said protein isolate/lecithin mixture is added to food, such as for example
bakery goods,
sausage and meat products,
ice cream,
sweets,
chocolates,
delicatessen products.
